(19) United States
(12) Patent Application Publication
(10) Pub. No.: US 2009/0070322 A1
(43) Pub. Date: Mar. 12, 2009

(54) BROWSING KNOWLEDGE ON THE BASIS OF SEMANTIC RELATIONS

(75) Inventors: FRANCO SALVETTI, San Francisco, CA (US); GIOVANNI LORENZO THIONE, San Francisco, CA (US); RICHARD S. CROUCH, Cupertino, CA (US); DAVID AHN, San Francisco, CA (US); LUKAS A. BIEWALD, San Francisco, CA (US); BRENDAN O'CONNOR, Mountain View, CA (US); BARNEY D. PELL, San Francisco, CA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Powerset, Inc., Redmond, WA (US)

(21) Appl. No.: 12/201,978

(22) Filed: Aug. 29, 2008

Related U.S. Application Data
(60) Provisional application No. 60/971,061, filed on Sep. 10, 2007.
(60) Provisional application No. 60/969,442, filed on Aug. 31, 2007.

(51) Int. Cl. G06F 7/06; G06F 17/30

(52) U.S. Cl. 707/5; 707/E17.014

(57) ABSTRACT

Computer-readable media and computer systems for conducting semantic processes to facilitate navigation of search results that include sets of tuples representing facts associated with content of documents in response to queries for information. Content of documents is accessed and semantic structures are derived by distilling linguistic representations from the content. Groups of two or more related words, called tuples, are extracted from the documents or the semantic structures. Tuples can be stored at a tuple index. Representations of the relational tuples are displayed in addition to documents retrieved in response to a query.

This non-provisional application claims the benefit of the following U.S. Provisional Applications having the respectively listed Application numbers and filing dates, and each of which is expressly incorporated by reference herein: U.S. Provisional Application No. 60/971,061, filed Sep. 10, 2007 and U.S. Provisional Application No. 60/969,442, filed Aug. 31, 2007.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Online search engines have become an increasingly important tool for conducting research or navigating documents accessible via the Internet. Often, the online search engines perform a matching process for detecting possible documents, or text within those documents, that corresponds with a query submitted by a user. Initially, the matching process, offered by conventional online search engines, such as those maintained by Google or Yahoo, allow the user to specify one or more keywords in the query to describe information that the user is looking for. Next, the conventional online search engine proceeds to find all documents that contain exact matches of the keywords and typically presents a result for each document as a block of text that includes one or more of the keywords.

Suppose, for example, that the user desired to discover which entity purchased the company PeopleSoft. Entering a query with the keywords “who bought PeopleSoft” to the conventional online engine produces the following as one of its results: “J. Williams was an officer, who founded Vantive in the late 1990s, which was bought by PeopleSoft in 1999, which in turn was purchased by Oracle in 2005.” In this result, the words from the retrieved text that exactly match the keywords “who,” “bought,” and “PeopleSoft,” from the query, are bold-faced to give some justification to the user as to why this result is returned. While this result does contain the answer to the user's query (Oracle), there are no indications in the display to draw attention to that particular word as opposed to the other company, Vantive, that was also the target of an acquisition. Moreover, the bold-faced words draw a user's attention towards the word “who,” which refers to J. Williams, thereby misdirecting the user to a person who did not buy PeopleSoft and who does not accurately satisfy the query. Accordingly, providing a matching process that promotes exact keyword matching is not efficient and often is more misleading than useful.

Present conventional online search engines are limited in that they do not recognize aspects of the searched documents corresponding to keywords in the query beyond the exact matches produced by the matching process (e.g., failing to distinguish whether PeopleSoft is the agent of the Vantive acquisition or the target of the Oracle acquisition). Also, conventional online search engines are limited because a user is restricted to using keywords in a query that are to be matched, and thus, do not allow the user to express precisely the information desired in the search results. Accordingly, implementing a natural language search engine to recognize semantic relations between keywords of a query and words in searched documents, as well as techniques for navigating search results and for highlighting these recognized words in the search results, would uniquely increase the accuracy of searches and would advantageously direct the user's attention to text in the searched documents that is most responsive to the query.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention generally relate to computer-readable media and a computer system for employing a procedure to navigate search results returned in response to a natural language query. In embodiments, the natural language query can be submitted by a user and in other embodiments, the natural language query can be automatically generated in response to a user's selection of a hyperlink. The search results can include documents that are matched with queries by determining that words within the query have the same relationship to each other as similar words within the documents. Navigation of the search results is facilitated by the presentation of a number of relational tuples, each of which represents a fact contained within a document or documents. A tuple includes a set of words that bear some expressible relation to each other.

As an example, one basic tuple is a triple, which includes three words having specific roles in an expression of a fact. The three roles can include, for example, a subject, an object, and a relation. In embodiments of the present invention, a relation is often a verb. However, in other embodiments, the relation need not be a surface grammatical relation like a verb that links a subject and object, but can include more semantically motivated relations. For example, such relations can normalize differences in passive and active voice. Similarly, tuples can be extracted from queries to facilitate efficient retrieval of relevant search results.

In some embodiments, a tuple contains only two words, such as the illustrative tuple, “bird: fly”. As in that example, a tuple may contain a subject and a relation or an object and a relation. In other embodiments, tuples can contain more than three elements, and can provide varying types and degrees of information about a search result. For example, if a search result that is responsive to a particular query includes a document about John F. Kennedy, one fact that might be contained in the document could be: “John F. Kennedy was shot by a mysterious man on Nov. 22, 1963.” An example of a triple that could be extracted from this fact includes: “man: shot: jfk”. Additionally, tuples can include synonyms and hypernyms (words that should be returned in response to a search for a certain word). Moreover, tuples can include additional information such as dates or other modifiers related to elements of the tuple. For example, an illustrative 4-tuple corresponding to the example above is “man: shot: jfk: in 1963”.

Accordingly, embodiments of the present invention exploit the linguistic structure of both queries and documents to retrieve, aggregate, and rank results retrieved in response to a query. These responses can be made available in the form of relational tuples together with the documents and sentences in which they appear, thereby providing users with an efficient system for browsing search results.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a schematic diagram of an exemplary overall system architecture suitable for use in implementing embodiments of the present invention;

FIG. 3 depicts an illustrative example of a semantic structure in accordance with an embodiment of the present invention;

FIGS. 4-5 depict illustrative examples of fact-based structures in accordance with an embodiment of the present invention;

FIG. 6 is a schematic diagram of an illustrative subset of processing steps performed within the exemplary system architecture, in accordance with an embodiment of the present invention;

FIG. 7 is a flow diagram illustrating an exemplary method of extracting and annotating tuples from content, in accordance with an embodiment of the present invention;

FIG. 8 is a schematic diagram of a subsystem of an exemplary system architecture in accordance with an embodiment of the present invention; and

FIGS. 9-11 are flow diagrams illustrating exemplary methods for returning relational tuples representing facts contained in documents retrieved in response to a query.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

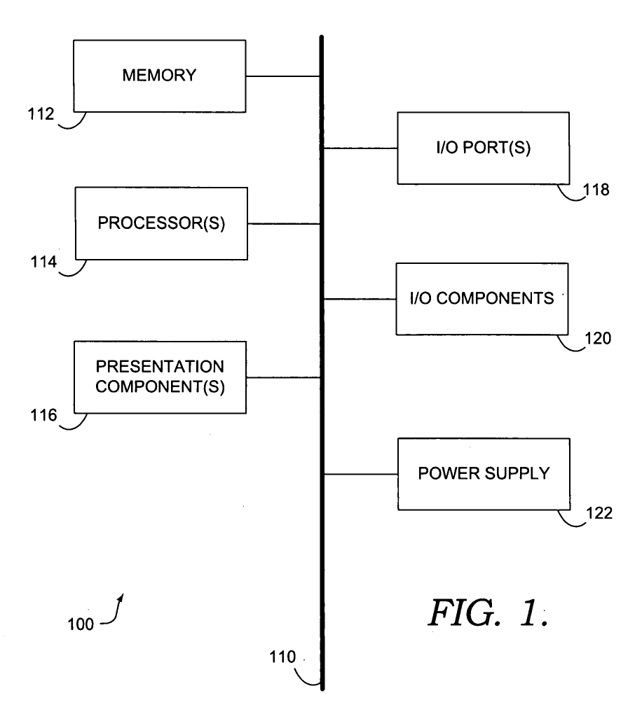

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks or implements particular abstract data types. Embodiments of the present invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear and, metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated to be within the scope of FIG. 1 in reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVDs) or other optical or holographic media; magnetic cassettes, magnetic tape, magnetic disk storage or other magnetic storage devices; or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

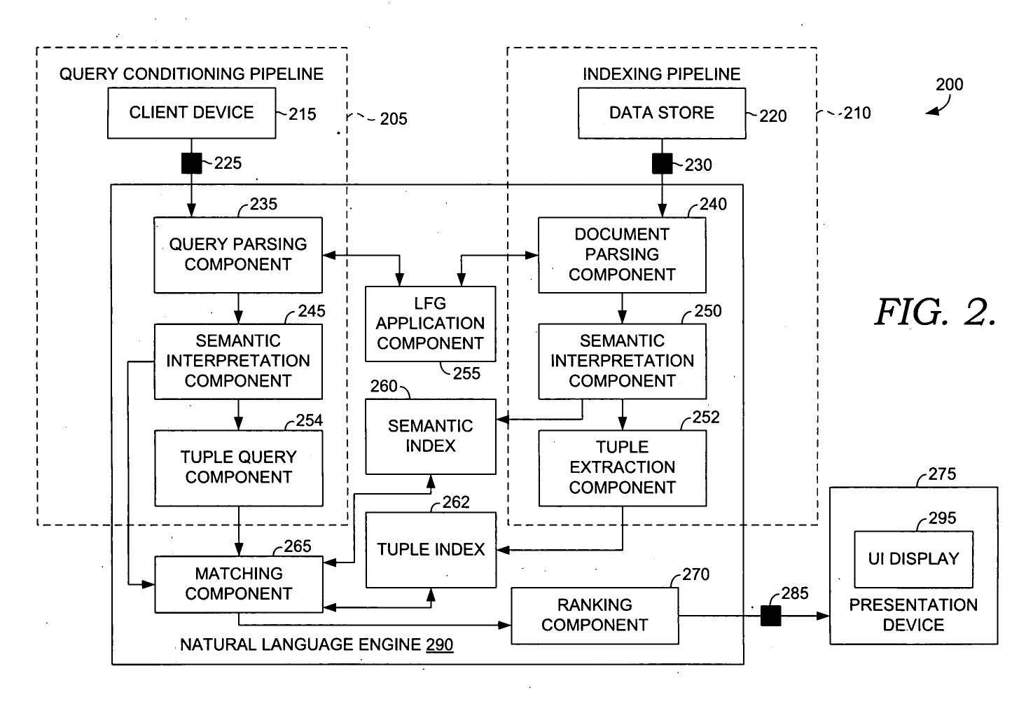

Turning now to FIG. 2, a schematic diagram of an exemplary overall system architecture 200 suitable for use in implementing embodiments of the present invention is shown. It will be understood and appreciated by those of ordinary skill in the art that the exemplary system architecture 200 shown in FIG. 2 is merely an example of one suitable computing environment and is not intended to suggest any limitation as to the scope of use or functionality of the present invention. Neither should the exemplary system architecture 200 be interpreted as having any dependency or requirement related to any single component or combination of components illustrated therein.

As illustrated, the system architecture 200 may include a distributed computing environment, where a client device 215 is operably coupled to a natural language engine 290, which, in turn, is operably coupled to a data store 220. In embodiments of the present invention that are practiced in the distributed computing environments, the operable coupling refers to linking the client device 215 and the data store 220 to the natural language engine 290, and other online components through appropriate connections. These connections can be wired or wireless. Examples of particular wired embodiments, within the scope of the present invention, include USB connections and cable connections over a network (not shown). Examples of particular wireless embodiments, within the scope of the present invention, include a near-range wireless network and radio-frequency technology.

It should be understood and appreciated that the designation of “near-range wireless network” is not meant to be limiting, and should be interpreted broadly to include at least the following technologies: negotiated wireless peripheral (NWP) devices; short-range wireless air interference networks (e.g., wireless personal area network (wPAN), wireless local area network (wLAN), wireless wide area network (wWAN), Bluetooth™, and the like); wireless peer-to-peer communication (e.g., Ultra Wideband); and any protocol that supports wireless communication of data between devices. Additionally, persons familiar with the field of the invention will realize that a near-range wireless network may be practiced by various data-transfer methods (e.g., satellite transmission, telecommunications network, etc.). Therefore it is emphasized that embodiments of the connections between the client device 215, the data store 220 and the natural language engine 290, for instance, are not limited by the examples described, but embrace a wide variety of methods of communications.

Exemplary system architecture 200 includes the client device 215 for, in part, supporting operation of the presentation device 275. In an exemplary embodiment, where the client device 215 is a mobile device for instance, the presentation device (e.g., a touchscreen display) may be disposed on the client device 215. In addition, the client device 215 can take the form of various types of computing devices. By way of example only, the client device 215 may be a personal computing device (e.g., computing device 100 of FIG. 1), handheld device (e.g., personal digital assistant), a mobile device (e.g., laptop computer, cell phone, media player), consumer electronic device, various servers, and the like. Additionally, the computing device may comprise two or more electronic devices configured to share information with each other.

In embodiments, as discussed above, the client device 215 includes, or is operably coupled to the presentation device 275, which is configured to present a user-interface (UI) display 295 on the presentation device 275. The presentation device 275 can be configured as any display device that is capable of presenting information to a user, such as a monitor, electronic display panel, touch-screen, liquid crystal display (LCD), plasma screen, or any other suitable display type, or may comprise a reflective surface upon which the visual information is projected. Although several differing configurations of the presentation device 275 have been described above, it should be understood and appreciated by those of ordinary skill in the art that various types of presentation devices that present information may be employed as the presentation device 275, and that embodiments of the present invention are not limited to those presentation devices 275 that are shown and described.

In one exemplary embodiment, the UI display 295 rendered by the presentation device 275 is configured to surface a web page (not shown) that is associated with natural language engine 290 and/or a content publisher. In embodiments, the web page may reveal a search-entry area that receives a query and presents search results that are discovered by searching the Internet with the query. The query may be manually provided by a user at the search-entry area, or may be automatically generated by software. In addition, as more fully discussed below, the query may include one or more keywords that, when submitted, invokes the natural language engine 290 to identify appropriate search results that are most responsive to keywords in a query.

The natural language engine 290, shown in FIG. 2, may take the form of various types of computing devices, such as, for example, the computing device 100 described above with reference to FIG. 1. By way of example only and not limitation, the natural language engine 290 may be a personal computer, desktop computer, laptop computer, consumer electronic device, handheld device (e.g., personal digital assistant), various remote servers (e.g., online server cloud), processing equipment, and the like. It should be noted, however, that the invention is not limited to implementation on such computing devices but may be implemented on any of a variety of different types of computing devices within the scope of embodiments of the present invention.

Further, in one instance, the natural language engine 290 is configured as a search engine designed for searching for information on the Internet and/or the data store 220, and for gathering search results from the information, within the scope of the search, in response to submission of a query via the client device 215. In one embodiment, the search engine includes one or more web crawlers that mine available data (e.g., newsgroups, databases, open directories, the data store 220, and the like) accessible via the Internet and build indexes 260 and 262 containing web addresses along with the subject matter of web pages or other documents stored in a meaningful format. In another embodiment, the search engine is operable to facilitate identifying and retrieving the search results (e.g., listing, table, ranked order of web addresses, and the like) from the indexes 260 and 262 that are relevant to search terms within a submitted query. The search engine may be accessed by Internet users through a web-browser application disposed on the client device 215. Accordingly, the users may conduct an Internet search by submitting search terms at a search-entry area (e.g., surfaced on the UI display 295 generated by the web-browser application associated with the search engine).

The data store 220 is generally configured to store information associated with online items and/or materials that have searchable content associated therewith (e.g., documents that comprise the Wikipedia website). In various embodiments, such information can include, without limitation, documents, unstructured text, text with metadata, structured databases, content of a web page/site, electronic materials accessible via the Internet or a local intranet, and other typical resources available to a search engine. All of these types of searchable content will generically be referred to herein as documents. In addition, the data store 220 can be configured to be searchable for suitable access of the stored information. For instance, the data store 220 may be searchable for one or more documents selected for processing by the natural language engine 290. In embodiments, the natural language engine 290 is allowed to freely inspect the data store for documents that have been recently added or amended in order to update the semantic index. The process of inspection may be carried out continuously, in predefined intervals, or upon an indication that a change has occurred to one or more documents aggregated at the data store 220. It will be understood and appreciated by those of ordinary skill in the art that the information stored in the data store 220 can be configurable and may include any information within a scope of an online search. The content and volume of such information are not intended to limit the scope of embodiments of the present invention in any way. Further, though illustrated as a single, independent component, the data store 220 may, in fact, be a plurality of databases, for instance, a database cluster, portions of which may reside on the client device 215, the natural language engine 290, another external computing device (not shown), and/or any combination thereof.

Generally, the natural language engine 290 provides a tool to assist users aspiring to explore and find information online. In embodiments, this tool operates by applying natural language processing technology to compute the meanings of passages in sets of documents, such as documents drawn from the data store 220. These meanings are stored in the semantic index 260 that is referenced upon executing a search. Additionally, simplified representations, referred to herein as tuples, of at least some of these meanings are stored in the tuple index 262. The tuple index 262 can also be referenced upon execution of a search. Initially, when a user enters a query into a search-entry area, a query conditioning pipeline 205 analyzes the query's keywords (e.g., a character string, complete words, phrases, alphanumeric compositions, symbols, or questions) and translates the query into a structural representation utilizing semantic relationships. This representation, referred to hereinafter as a “proposition,” may be utilized to interrogate information stored in the semantic index 260 to arrive upon relevant search results. The proposition can be further translated into a tuple query, which is structured for querying the tuple index 262.

In an embodiment, the information stored in the semantic index 260 includes representations extracted from the documents maintained at the data store 220, or any other materials encompassed within the scope of an online search. This representation, referred to herein as a “semantic structure” relates to the intuitive meaning of content distilled from common text and may be stored in the semantic index 260. The architecture of the semantic index 260 can therefore allow for rapid comparison of the stored semantic structures against the derived propositions in order to find semantic structures that match the propositions and to retrieve documents mapped to the semantic structures that are relevant to the submitted query. It should be appreciated by those having ordinary skill in the art that semantic index 260 can be implemented in a variety of configurations.

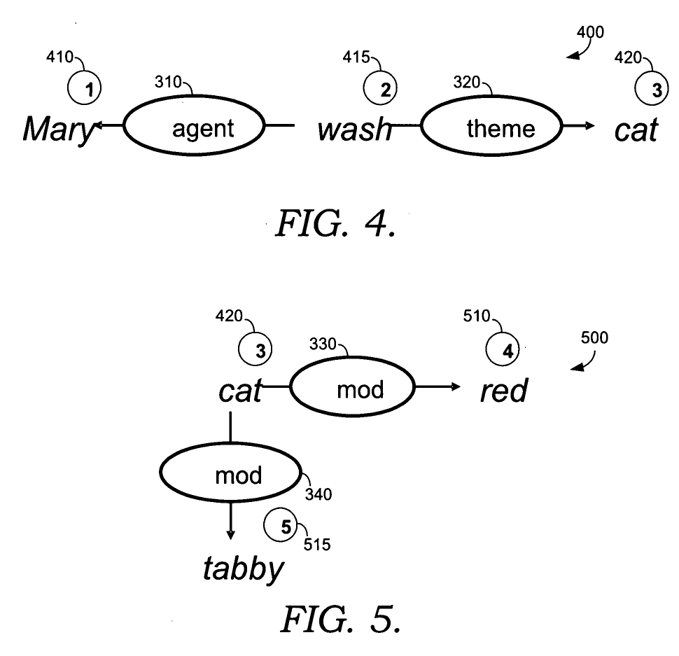

According to another embodiment, semantic index 260 stores semantic structures by generating fact-based structures related to facts contained in each semantic structure. In a further embodiment, fact-based structures are generated by semantic interpretation component 250. According to some embodiments, a fact-based structure is generated using, for example, information provided from the indexing pipeline 210 from FIG. 2. Such information has been parsed and the semantic relationship between the terms has been determined before being received at the semantic index 260. In embodiments of the present invention, as discussed above, this information is in the form of a semantic structure and in other embodiments, the information is in the form of a fact-based structure derived from a semantic structure. Furthermore, an identifier can be provided to each node of a fact-based structure, which will be discussed further below with respect to FIGS. 4 and 5.

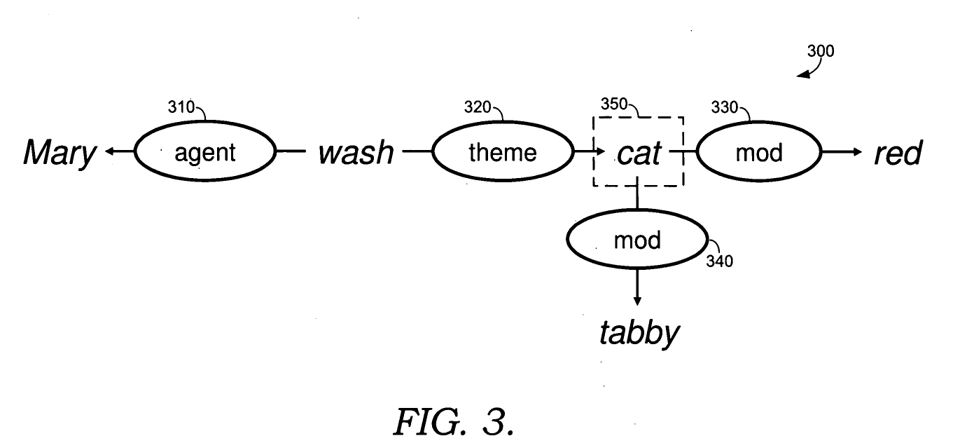

A fact-based structure, as used herein, refers to a structure associated with each core element, or fact, of the semantic structure. As illustrated in FIGS. 3-5, in an embodiment, a fact-based structure contains various elements, including nodes and edges. One skilled in the art, however, will appreciate that a fact-based structure is not limited to this specific structure. Each node in a fact-based structure, as used herein, represents the elements of the semantic structure, where the edges of the structure connect the nodes and represent the relationships between those elements. In embodiments, the edges may be directed and labeled, with these labels representing the roles of each node.

With continued reference to FIG. 2, the architecture of the tuple index 262 allows for rapid comparison of the stored tuples against the derived tuple queries in order to find tuples that match the tuple queries and to retrieve documents mapped to the tuples that are relevant to the submitted query. Accordingly, the natural language engine 290 can determine the meaning of a user's query requirements from the keywords submitted into a search interface (e.g., the search-entry area surfaced on the UI display 295), and then sift through a large amount of information to find corresponding search results that satisfy those needs.

In embodiments, the process above may be implemented by various functional elements that carry out one or more steps for discovering relevant search results. These functional elements include a query parsing component 235, a document parsing component 240, a semantic interpretation component 245, a semantic interpretation component 250, a tuple extraction component 252, a tuple query component 254, a grammar specification component 255, the semantic index 260, the tuple index 262, a matching component 265, and a ranking component 270. These functional components 235, 240, 245, 250, 252, 254, 255, 260, 262, 265, and 270 generally refer to individual modular software routines, and their associated hardware that are dynamically linked and ready to use with other components or devices.

Initially, the data store 220, the document parsing component 240, the semantic interpretation component 250, and the tuple extraction component 252 comprise an indexing pipeline 210. In operation, the indexing pipeline 210 serves to distill the functional structure from content within documents 230 accessed at the data store 220, and to construct the semantic index 260 upon gathering the semantic structures and the tuple index upon extracting and annotating tuples from the semantic structures or from fact-based structures derived from semantic structures. As discussed above, when aggregated to form the indexes 260 and 262, the semantic structures and tuples may retain mappings to the documents 230, and/or location of content within the documents 230, from which they were derived.

Generally, the document parsing component 240 is configured to gather data that is available to the natural language engine 290. In one instance, gathering data includes inspecting the data store 220 to scan content of documents 230, or other information, stored therein. Because the information within the data store 220 may be constantly updated, the process of gathering data may be executed at a regular interval, continuously, or upon notification that an update is made to one or more of the documents 230.

Upon gathering the content from the documents 230 and other available sources, the document parsing component 240 performs various procedures to prepare the content for semantic analysis thereof. These procedures may include text extraction, entity recognition, and parsing. The text extraction procedure substantially involves extracting tables, images, templates, and textual sections of data from the content of the documents 230 and converting them from a raw online format to a usable format (e.g., HyperText Markup Language (HTML)), while saving links to documents 230 from which they are extracted in order to facilitate mapping. The usable format of the content may then be split up into sentences. In one instance, breaking content into sentences involves assembling a string of characters as an input, applying a set of rules to test the character string for specific properties, and, based on the specific properties, dividing the content into sentences. By way of example only, the specific properties of the content being tested may include punctuation and capitalization in order to determine the beginning and end of a sentence. Once a series of sentences is ascertained, each individual sentence is examined to detect words therein and to potentially recognize each word as an object (e.g., “The Hindenburg”), an event (e.g., “World War II”), a time (e.g., “September”), or any other category of word that may be utilized for promoting distinctions between words or for understanding the meaning of the subject sentence.

The entity recognition procedure assists in recognizing which words are names, as they provide specific answers to question-related keywords of a query (e.g., who, where, when). In embodiments, recognizing words includes identifying a word as a name and annotating the word with a tag to facilitate retrieval when interrogating the semantic index 260. In one instance, identifying words as names includes looking up the words in predefined lists of names to determine if there is a match. If no match exists, statistical information may be used to guess whether the word is a name. For example, statistical information may assist in recognizing a variation of a complex name, such as “USS Enterprise,” which may have several common variations in spelling.

The parsing procedure, when implemented, provides insights into the structure of the sentences identified above. In one instance, these insights are provided by applying rules maintained in a framework of the grammar specification component 255. When applied, these rules, or grammars, expedite analyzing the sentences to distill representations of the relationships among the words in the sentences. As discussed above, these representations are referred to as semantic structures, and allow the semantic interpretation component 250 to capture critical information about the structure of the sentence (e.g., verb, subject, object, and the like).

The semantic interpretation component 250 is generally configured to diagnose the role of each word in the semantic structure by recognizing a semantic relationship between the words. Initially, diagnosing may include analyzing the grammatical organization of the semantic structure and separating the semantic structure into logical assertions (e.g., prepositional phrases) that each express a discrete idea and particular facts. These logical assertions may be further analyzed to determine a function of each of a sequence of words that comprises the assertion. If appropriate, based on the function or role of each word, one or more of the sequence of words may be expanded to include synonyms (i.e., linking to other words that correspond to the expanded word's specific meaning) or hypernyms (i.e., linking to other words that generally relate to the expanded word's general meaning). This expansion of the words, the function each word serves in an expression (discussed above), a grammatical relationship of each of the sequence of words, and any other information about the semantic structure, recognized by the semantic interpretation component 250, can be represented as a “semantic word,” which can be a fact-based structure, a semantic structure, or the like and is stored at the semantic index 260. Accordingly, a sentence, which, as used herein, can include a phrase, a passage, a portion of text, or some other representation extracted from content, can be represented by a sequence of semantic words. Additionally, sets of semantic words that are outputted by the semantic interpretation component 250 will generally be referred to herein as “content semantics.”

The semantic index 260 serves to store the information about the semantic structure derived by the indexing pipeline 210 and may be configured in any manner known in the relevant field. By way of example, the semantic index 260 may be configured as an inverted index that is structurally similar to conventional search engine indexes. In this exemplary embodiment, the inverted index is a rapidly searchable database whose entries are words with pointers to the documents 230, and locations therein, on which those words occur. Accordingly, when writing the information about the semantic structures to the semantic index 260, each word and associated function is indexed as a semantic word along with the pointers to the sentences in documents in which the semantic word appeared. This framework of the semantic index 260 allows the matching component 265 to efficiently access, navigate, and match stored information to recover meaningful search results that correspond with the submitted query.

Content semantics, i.e., sets of semantic words, can be sent to the tuple extraction component 252 for processing. Content semantics can be sent to the tuple extraction component 252 as they are created or in groups organized by sentences, paragraphs, documents, sources, or the like. Content semantics can be formatted in a number of different ways. In one embodiment, for example, a set of content semantics are sent to the tuple extraction component 252 as an extensible markup language (XML) document. In other embodiments, content semantics can be sent in other formats such as HTML and the like. The tuple extraction component 252 processes content semantics by extracting tuples from the content semantics and, in some embodiments, annotating them.

It should be noted that a number of different types of content can be processed by the tuple extraction component 252, including, for example, content semantics, documents, sentences, phrases, parsed language, textual representations of images, videos, recorded speech, and the like. In one embodiment, the tuple extraction component 252 processes semantic representations of “facts.” In another embodiment, the tuple extraction component 252 processes natural language input. It should be understood that other embodiments can include representations of facts that vary from those described herein. For example, techniques other than graphing can be used to represent facts such as techniques associated with building relational databases, tables, and the like.

Tuples, as used herein, include small groups of related words, and their respective roles, that have been extracted from a document and can be used to generate a simple, easily understandable visualization related to a result from a search query. In an embodiment, a tuple represents an answer to the following generic question about a fact, sentence, portion of content, or other indexed element: Who Do To What? Accordingly, a tuple will usually include a subject, a relation (e.g., a predicate, or verb), and an object. In other embodiments, a tuple can include other types of elements that are more semantically motivated than surface grammatical relations like subject and object. For example, a relation can be constructed to normalize differences in passive and active voice or to express congruence between a set of abstract concepts. However, for the purposes of simplicity and clarity of explanation, the following discussion will focus on relations that include a subject and an object. One basic type of tuple includes only these three elements, and is referred to herein as a triple. Tuples can include, for example, triples that have been augmented with additional data that enriches the represented information about a fact. For example, other elements that answer questions such as “When?,” “Where?,” “How?,” and the like can be included. The creation of tuples will be further explained later, although their role in the overall exemplary system illustrated in FIG. 2 is evident in the following discussion.

The tuple extraction component 252 compiles sets of tuples (including corresponding annotations) into documents such as XML documents that can be used for indexing in the tuple index 262. In an embodiment, the tuple extraction component 252 generates two output documents for each set of tuples. The first document is essentially a stripped version of the input content semantics documents, and in an embodiment, is generated in the same format as the input such as XML. Additionally, the tuples are converted, if necessary, to lowercase text and are lemmatized for aggregation. A second document can also be created that includes an even further stripped version of the input. The data in the second document can be formatted in an even simpler and computationally more efficient manner than XML and includes what will be referred to herein as “opaque data,” because it is opaque with respect to the tuple index 262. That is, opaque data is efficiently stored in an opaque data store such that it is not directly included within the tuple index 262, but corresponds to the tuple index 262. For the purposes of clarity, the storage module for the opaque data is not reflected in FIG. 2, but rather can be thought of as being adjoined to, or embedded within the tuple index 262. The tuples stored in the tuple index 262 can include pointers (i.e., references) to corresponding opaque data. In an embodiment, the opaque data is the data that is returned in response to a search request to create a visualization of the search results. Thus, for example, opaque data can include data that can cause the UI display 295 to render text that includes tuples or short phrases or sentences based on tuples. Accordingly, opaque data can be processed to generate text of varying formats such as, for example, HTML, rich text format (RTF), and the like.

The tuple index 262 serves to store the information about the functional structure derived by the indexing pipeline 210 that has been extracted as tuples and may be configured in any manner known in the relevant field. By way of example, the tuple index 262 may be configured as an inverted index that is structurally similar to conventional search engine indexes. In this exemplary embodiment, the inverted tuple index is a rapidly searchable database whose entries are words with pointers to the documents 230, as well as to corresponding opaque data. The entries also include pointers to locations in the documents where the indexed words occur. Accordingly, when writing the information about the tuples to the tuple index 262, each word and associated tuple is indexed along with the pointers to the sentences in documents in which the tuple appeared. This framework of the tuple index 262 allows the matching component 265 to efficiently access, navigate, and match stored information to recover meaningful, yet simple search results that correspond to the submitted query.

The client device 215, the query parsing component 235, the semantic interpretation component 245, and the tuple query component 246 comprise a query conditioning pipeline 205. Similar to the indexing pipeline 210, the query conditioning pipeline 205 distills meaningful information from a sequence of words. However, in contrast to processing passages within documents 230, the query conditioning pipeline 205 processes keywords submitted within a query 225. For instance, the query parsing component 235 receives the query 225 and performs various procedures to prepare the keywords for semantic analysis thereof. These procedures may be similar to the procedures employed by the document parsing component 240 such as text extraction, entity recognition, and parsing. In addition, the structure of the query 225 may be identified by applying rules maintained in a framework of the grammar specification component 255, thus, deriving a meaningful representation, or proposition, of the query 215.

In embodiments, the semantic interpretation component 245 may process the proposition in a substantially comparable manner as the semantic interpretation component 250 interprets the semantic structure derived from a passage of text in a document 230. In other embodiments, the semantic interpretation component 245 may identify a grammatical relationship of the keywords within the string of keywords that comprise the query 225. By way of example, identifying the grammatical relationship includes identifying whether a keyword functions as the subject (agent of an action), object, predicate, indirect object, or temporal location of the proposition of the query 255. In another instance, the proposition is evaluated to identify a logical language structure associated with each of the keywords. By way of example, evaluation may include one or more of the following steps: determining a function of at least one of the keywords; based on the function, replacing the keywords with a logical variable that encompasses a plurality of meanings; and writing those meanings to the proposition of the query. This proposition of the query 225, the keywords, and the information distilled from the proposition and/or keywords comprise the output of the semantic interpretation component 245. This output will be generally referred to herein as “query semantics.” The query semantics are sent to one or both of the tuple query component 254 for further refinement in preparation for comparison against the tuple index 262 and the matching component 265 for comparison against the semantic structures extracted from the documents 230 and stored at the semantic index 260.

According to embodiments of the present invention, the tuple query component 254 further refines the query semantics into a tuple query that can be compared against the tuples extracted from content semantics corresponding to the documents 230 and stored at the tuple index 262. In embodiments, the tuple query component 254 examines the query semantics to isolate tuples. This procedure can be similar to the procedure employed by the tuple extraction component 252, except that the tuple query component 254 does not generally annotate the tuples derived from the query semantics. To effectively query the tuple index 262, search tuples are extracted from the query semantics.

In some cases, however, a query, and thus the resulting query semantics, may not include one or more of the elements (or roles) of a tuple, as defined herein. In these cases, the tuple query component 254 can substitute the missing element with a “wildcard” element. In an embodiment, this wildcard element can be assigned a particular role (e.g., subject, relation, object, etc.) such that the search results returned in response to the query contains a number of relevant tuples, each possibly having a different word that corresponds to that role. In other embodiments, the wildcard element may be assigned a particular word, but have a variable role such that search results returned in response thereto include a number of tuples that include that word, but where that word may possibly have a different corresponding role in each tuple. In some cases, more than one basic element of a tuple could be missing, in which case the search tuple may contain more than one wildcard element. Understandably, a tuple query resulting from a single query 225 could include any number of search tuples, depending on the nature of the original query 225. The generated tuple query is sent to the matching component for comparison against the tuple index 262.

In an exemplary embodiment, the matching component 265 compares the propositions of the queries 225 against the semantic structures at the semantic index 260 to ascertain matching semantic structures and compares the tuple queries against the indexed tuples at the tuple index 262 to ascertain matching tuples. These matching semantic structures and tuples may be mapped back to the documents 230 from which they were extracted utilizing the tags appended to the semantic structures and the pointers appended to the tuples, which themselves may include or be derived from the tags. These documents 230 are collected and sorted by the ranking component 270. Additionally, textual representations of the tuples, generated from opaque data, can be returned and/or sorted in addition to, or instead of, the documents 230. Sorting may be performed in any known method within the relevant field, and may include without limitation, ranking according to closeness of match, listing based on popularity of the returned documents 230, or sorting based on attributes of the user submitting the query 225. These ranked documents 230 and/or tuples comprise the search result 285 and are conveyed to the presentation device 275 for surfacing in an appropriate format on the UI display 295.

Accordingly, search results can be made available, in an embodiment, in the form of relational tuples together with the documents and sentences in which they appear. In an embodiment, tuples can be useful in ranking search results 285. For example, inexact matches can be ranked lower than exact matches or types of inexact matches can be ranked differently relative to each other. Results can also be ranked by any measure of interestingness or utility associated with the facts retrieved. In this way, for example, matches returned in response to a partial-relation query such as <Picasso, paint> can be ranked by the terms that complete the relation (or tuple). In some embodiments, such a partial-relation query can be entered directly by a user and in other embodiments, a partial-relation query can be generated by the tuple query component 252.

In embodiments, documents retrieved in response to such a structured query can be hierarchically organized according to the values of the roles in the linguistic relations that match the query, providing a different way to visualize search results than the traditional ranked list of document identifiers and snippets. In such a visualization, clusters of documents can be associated with partial linguistic relations using aggregations of tuples. Additional information associated with each cluster can include the number of clustered elements, measures of confirmation or diversity of the elements, and significant concepts expressed in the cluster.

Results displayed as clustered relations using tuples can also include automatically generated queries in different forms (e.g., natural language queries) that correspond to the relationships in the cluster. For example, the partial relation <Picasso, paint> can be linked to a natural language query such as “What did Picasso paint?,” where this query is issued to a natural language search engine when a user clicks on a provided link. Similarly, in response to the natural language query “What did Picasso paint?,” the clustered representation corresponding to the partial relation <Picasso, paint> can be presented. In this way, the clustering interface can be joined to a natural language search system whether users initially enter queries in a natural language form or a structured linguistic form.

In embodiments, elements of partial relations can be displayed as hyperlinks to automatically generated structured queries that allow for further exploration of related knowledge. In an embodiment, a simple automatically generated query searches for the hyperlinked term in a specific role. Thus, for example, given a partial relation such as <Picasso, paint>, the term “Picasso” could be hyperlinked to a query that performs a search for “Picasso” as an object instead of a subject. More complex queries can also be generated that take into account the other elements in the relation and the original query itself. For example, given a query for “Picasso” as a subject and the retrieved tuple, or relation, <Picasso, paint, Guernica>, the term “paint” could be hyperlinked to a query for “paint” as a relation to retrieve other subjects and objects of “paint.” In another embodiment, the query could be hyperlinked to a query for “paint” as a relation to “Picasso” as its subject, thus searching for other objects that Picasso has painted. As another example, given the same query and relation, “Guernica” could be hyperlinked to a query in which “Guernica” is the subject rather than the object and in which “Picasso” also appears somewhere else in the document (although not necessarily in the same relation).

In further embodiments, tuples allow for visualizations that include snippets of retrieved documents having elements of the partial relations occurring in the snippets (or other interesting terms in the snippets) that are hyperlinked to automatically generated queries. In general, any term, whether in the displayed partial relation or in the displayed snippets, can be hyperlinked to a query that looks for the term itself in a role and nay related terms in other roles. The decision about which roles and related terms to use can be made in advance or on the fly such as, for example, via interaction with a user, through an adaptive process that determines which are the most interesting, through a set of rules, through heuristics, and the like.

In another embodiment, tuples can facilitate staged clustering of search results. A staged process of clustering can be implemented that allows aggregation of a large amount of data at runtime without delays that may be unacceptable to a user. A large but limited number of tuples can be aggregated and presented to the user. The staged aggregation process can be implemented using, for example, a caching mechanism that allows for the progressive integration of new chunks of data to take place in a timely manner. After reviewing the aggregated information, the user can explicitly ask for additional data to be aggregated with the displayed tuples. In various embodiments, progressive integration can take place on demand or, in other embodiments, can be performed in the background such that they are available in response to a user request. Requests can be made, for example, by clicking on an icon, voice command, or any other method of signaling user intent to the system. Visualization methods can be implemented to aid the user in distinguishing between results re-aggregated with new data and results that are already available for inspection.

With continued reference to FIG. 2, this exemplary system architecture 200 is but one example of a suitable environment that may be implemented to carry out aspects of the present invention and is not intended to suggest any limitation as to the scope of use or functionality of the invention. Neither should the illustrated exemplary system architecture 200, or the natural language engine 290, be interpreted as having any dependency or requirement relating to any one or combination of the components 235, 240, 245, 250, 252, 254, 255, 260, 262, 265, and 270 as illustrated. In some embodiments, one or more of the components 235, 240, 245, 250, 252, 254, 255, 260, 262, 265, and 270 may be implemented as stand-alone devices. In other embodiments, one or more of the components 235, 240, 245, 250, 252, 254, 255, 260, 262, 265, and 270 may be integrated directly into the client device 215. It will be understood by those of ordinary skill in the art that the components 235, 240, 245, 250, 252, 254, 255, 260, 262, 265, and 270 illustrated in FIG. 2 are exemplary in nature and in number and should not be construed as limiting.

Accordingly, any number of components may be employed to achieve the desired functionality within the scope of embodiments of the present invention. Although the various components of FIG. 2 are shown with lines for the sake of clarity, in reality, delineating various components is not so clear, and metaphorically, the lines would more accurately be grey or fuzzy. Further, although some components of FIG. 2 are depicted as single blocks, the depictions are exemplary in nature and in number and are not to be construed as limiting (e.g., although only one presentation device 275 is shown, many more may be communicatively coupled to the client device 215).

FIG. 3 illustrates a semantic structure 300 in accordance with an embodiment of the present invention. This illustrated semantic structure represents an interim structure that the component generation component 265 utilizes to generate a semantic word, which, according to an embodiment, is a fact-based structure derived from a semantic structure. Fact-based structures include structures derived from semantic structures, and can be used to efficiently index semantic structures. Here, the original sentence is “Mary washes a red tabby cat.” As discussed above, the indexing pipeline 210 in FIG. 2 has identified the words or terms and the relationship between these words or terms. In one example, these relationships for the sentence may be represented as:

agent (wash, Mary)

theme (wash, cat)

mod (cat, red)

mod (cat, tabby)

In other words, “agent” describes the relationship between Mary and wash. Thus, in FIG. 3, the edge 310 connecting the nodes Mary and wash is labeled as “agent.” Further, “theme” describes the relationship between wash and cat, and edge 320 is labeled accordingly. The term “mod” indicates that the terms red and tabby modify cat. These roles are then used to label edges 330 and 340. It will be understood that these labels are merely examples, and are not intended to limit the present invention.

A structure is generated for each node that is the target of one or more edges. The term, cat, illustrated as node 350, is referred to herein as a head node. A head node is a node that is the target of more than one edge. In this example, cat relates to three other nodes (e.g., wash, red, and tabby), and thus, would be a head node. The structure 300 contains two facts, one around the head node wash and one around the head node cat. The semantic structure illustrated by structure 300 allows the dependency between the nodes or words within the sentence to be displayed.

In FIG. 4, the structure 300 of FIG. 3 is divided such that, with cat as a head node, only one fact within the semantic structure is illustrated as structure 400. This fact-based structure illustrates the first fact in the semantic structure, one that revolves around the wash node. FIG. 5 illustrates semantic word 500, a fact-based structure that revolves around the second fact in the semantic structure, or the cat node.

Additionally, an identifier can be assigned to each node, for example, by utilizing the identifying component 266 in FIG. 2. In embodiments of the invention, this identifier is referred to as a skolem identifier. One identifier is assigned to one term, regardless of whether the term is included on more than one semantic word. Here, as shown in FIG. 4, the Mary node is assigned identifier 410, as “1”. The wash node is assigned identifier 415, as “2”. And, the cat node is assigned identifier 420, as “3”. Because the cat node is also included in the semantic word 500 in FIG. 5, it is assigned the same identifier 420. Red and tabby are assigned identifiers 510 and 520, respectively.

Not only is each term assigned the same identifier, but each entity is assigned the identifier. An entity, as referred to herein, describes different terms that represent the same thing. For example, if the sentence were “Mary washes her red tabby cat.” Her would be illustrated as a node, and although it is a different term than Mary, it still represents the same entity as Mary. Thus, in a fact-based structure of this sentence, the Mary and her node would be assigned the same identifier. By storing the facts corresponding to 400 and 500 separately in the semantic index, and using identifiers to link nodes that are the same, encoding of the graph 300 is achieved that allows for superior retrieval efficiency over earlier methods of storing graphs. Additionally, semantic word 500 can include synonyms, hypernyms, and the like.

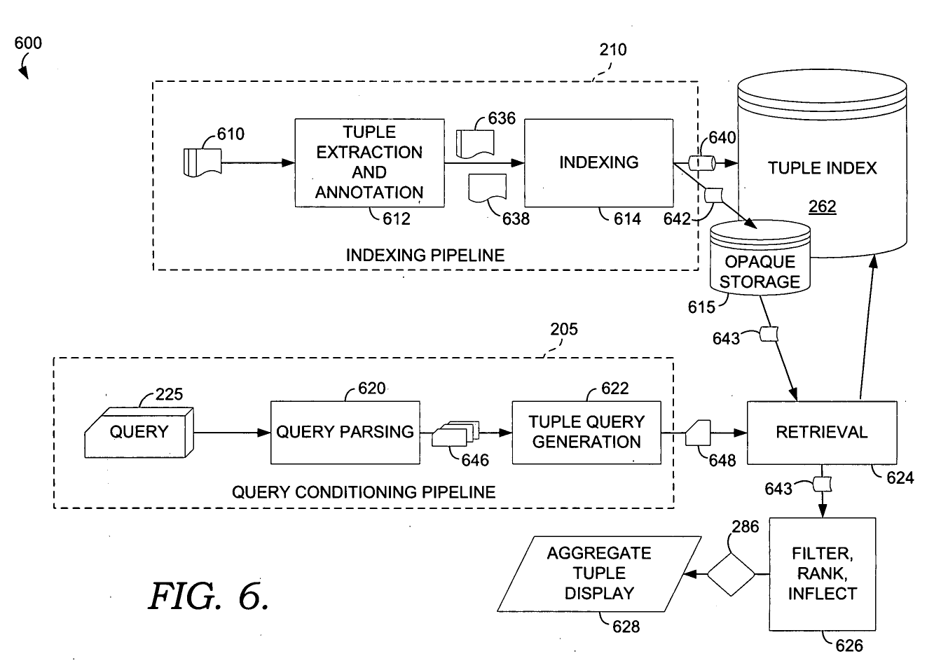

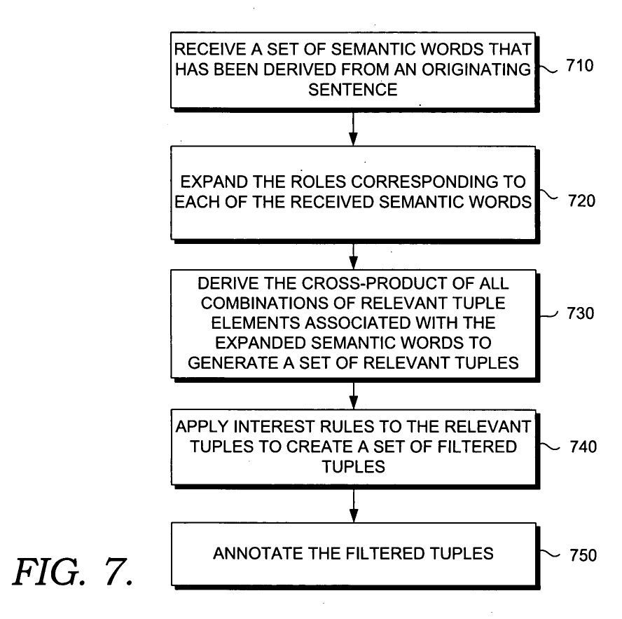

Turning now to FIG. 6, a schematic diagram shows an illustrative subset 600 of processing steps corresponding to an implementation of the exemplary system architecture in accordance with an embodiment of the present invention. The subset 600 of processing steps includes processing performed in the query conditioning pipeline 205 and the indexing pipeline 210. Processes illustrated within the query conditioning pipeline 205 include query parsing 620 and tuple query generation 622 (semantic query interpretation such as that performed by the semantic interpretation component 245 illustrated in FIG. 2 is not illustrated, but may be considered to be included in the query parsing 620 process). In some embodiments, the system can be configured to perform tuple query generation 622 on a parsed query without first processing the query in a semantic interpretation component 245. Processes illustrated within the indexing pipeline 210 include tuple extraction and annotation 612 and indexing 614. Additional processes illustrated include retrieval 624, filter, rank, and inflect 626, and aggregate tuple display 628. The tuple index 262 and opaque storage 315 are also illustrated for clarity.

According to embodiments of the invention, content semantics 610 are received, for example, from the semantic interpretation component 250, shown in FIG. 2, and are subjected to tuple extraction and annotation 612. Content semantics 610 can include one or more sets or sequences of semantic words. As explained above, tuple extraction and annotation 612 includes extracting sets of tuples from the content semantics 610, annotating the tuples, and outputting the tuples for indexing 614.

Tuple extraction and annotation 612 processes semantic content according to several steps. In some embodiments, one or more of the following steps can be omitted, and in other embodiments, additional steps may be included. One illustrative embodiment of the tuple extraction and annotation 612 process is illustrated in the flow chart shown in FIG. 7. This illustrative method initially includes, at step 710, receiving a set of semantic words that has been derived from an originating sentence. In embodiments, an originating sentence can be a sentence from some content such as a document and but can also include phrases, passages, titles, names, and other strings of text that are not actually sentences. Accordingly, as the term is used herein, originating sentences can include any portion of content that is extracted from content and eventually represented by one or more sets of tuples. For example, in various embodiments, originating sentences can include linguistic representations of non-textual content such as images, sounds, movies, abstract concepts (e.g., mathematical equations), rules, and the like.

Additionally, as explained above with respect to the description of FIG. 2, a semantic word can include a word and a role associated with that word. The role associated with the word can be the role of the word in relation to the other words in the originating sentence. The words in a sentence have defined roles in relation to one another. For example, in the sentence “John reads a book at work,” John is the subject, book is the object, and read is a verb that forms a relationship between John and the book. “Read” and “work” are in a relationship described by “at.” Additionally, multiple words in a sentence may have the same role. Also, a sentence could have more than one subject or object. According to some embodiments, roles can take various forms and can be expanded according to hierarchies. For instance a word can be assigned a subject role, an object role, or a relation role. Expanded roles associated with a subject role can include synonyms and hypernyms associated with the word and can include additional levels of description such as, for example, core, initiator, effecter, and the like.

For example, in the sentence “John reads a book at work” at could be role type that describes when John reads or where John reads. A word is determined to have more than one potential role by referencing one or more role hierarchies. A role hierarchy includes at least two levels. The first level, or root node, is a more general expression of a relationship between words. The sublevels below the root node contain more specific embodiments of the relationship described by the root note.

With continuing reference to FIG. 7, the roles of each of the semantic words are expanded at step 720. At step 730, the tuple extracting and annotation 612 process includes deriving the cross-product of all combinations of relevant tuple elements associated with the expanded semantic words to generate a set of relevant tuples. Each tuple is an atomic representation of a relation and is comprised of at least two words and their corresponding roles. For example, a 3-tuple (i.e., triple) might contain the following roles: a subject, a relation, and an object. Although the elements of a tuple will generally be discussed in terms of words, it should be understood that, as used herein, the term “word” can actually include more than one word, such as when an element can only be described with more than one word. Examples in which two or more words may be referred to, herein, as a “word” include, for example, proper names (e.g., John F. Kennedy), dates (e.g., April 3^{rd}), times (e.g., 9:15 a.m.), places (e.g., east coast), and the like. However, because a tuple is an atomic representation, it will contain only one of each role. Thus, a triple contains only one subject, one relation, and one object. More complex tuples, however, can contain additional words that, for example, identify an aspect of one of the other words. Tuples can contain any number of elements desired. However, processing requirements can be minimized by limiting the number of elements in the tuples. Thus, for example, in various embodiments, tuples contain three or four elements. In other embodiments, tuples can contain five or six elements. In still further embodiments, tuples can contain large numbers of elements.

To illustrate an example of a 3-tuple, i.e., a triple, suppose the semantic content received at step 710 includes a sequence of semantic words that represents the following originating sentence: “Jennifer also had noticed how people in the Chelsea district all have dogs and love their dogs so she subverted “lost dog” posters.” The following 3-word tuple (i.e., a triple) representing a fact can be extracted: people: love: dogs. As a result of the function of each of the words within the originating sentence, each of these three words have been assigned a role. People is a subject of the fact, and thus is assigned a subject role. A hypernyms for people is entity, which can be a generic placeholder for any type of noun, in this case, and thus the semantic word corresponding to people also includes an expanded role associated with entity. For brevity, a word and its corresponding role can be represented as follows: “word.role”. Additionally, throughout the present discussion, the following common roles are abbreviated as follows: subject—sb; object—ob.; and relation—rel.

Thus, the semantic word representing people includes the following: people.sb and entity.sb. Accordingly, the semantic word representing love includes love.rel., and entity.rel., where entity is a generic verb in this instance. Finally, the semantic word representing dogs can include dogs.ob, dog.ob, and entity.ob. Of course, each of these semantic words can, according to embodiments, contain any number of other expanded roles, but for the purposes of clarity and brevity of the following discussion, they shall be limited as indicated above. In accordance with the expanded roles defined above, after expanding each of the semantic words, the set of expanded semantic words includes the following tuple elements:

people.sb

entity.sb

love.rel

entity.rel

dog.ob

dogs.ob

entity.ob

It should be noted at this point, that this single tuple can include a number of different realizations because of the possibility of utilizing either the surfaceform (the word as it appears in the document) or the entity expansion. These realizations include, for example:

people,love,dog

people,love,dogs

people,love,entity

people,entity,dog

people,entity,dogs

people,entity,entity

entity,love,dog

entity,love,dogs

entity,love,entity

entity,entity,dog

entity,entity,dogs

entity,entity,entity

As is evident throughout the discussion, a tuple element is one entry in a tuple. Thus, a triple includes three tuple elements, a 4-tuple includes four tuple elements, and so on. Because the generation of tuples, as described herein, is motivated by the desire to display beneficial visualization of facts associated with search results, it is only necessary to compute the cross-products of tuples that include relations that correspond to the originating sentence.

Thus, in another example, a document could contain a sentence like “John and Mary eat apples and oranges.” An expansion, represented in XML, of one of the semwords associated with this fact, for instance “John” could include the following:

```
<fact>
  <semword role=“sb” rolehier=“sb/root//E/vgrel/root” sp_cmt=“p”
skolem=“761”>
  <semcode syn=“toilet#n#1” weight=“13” />
  <semcode hyp=“room#n#1” weight=“13” />
  <semcode hyp=“area#n#4” weight=“13” />
  <semcode hyp=“structure#n#1” weight=“13” />
  <semcode hyp=“artifact#n#1” weight=“13” />
  <semcode hyp=“whole#n#2” weight=“13” />
  <semcode hyp=“object#n#1” weight=“15” />
  <semcode hyp=“physical_entity#n#1” weight=“15” />
  <semcode hyp=“entity#n#1” weight=“15” />
  <semcode hyp=“customer#n#1” weight=“10” />
  <semcode hyp=“consumer#n#1” weight=“10” />
  <semcode hyp=“user#n#1” weight=“10” />
  <semcode hyp=“person#n#1” weight=“10” />
  <semcode hyp=“organism#n#1” weight=“10” />
  <semcode hyp=“causal_agent#n#1” weight=“10” />
  <semcode hyp=“living_thing#n#1” weight=“10” />
  <original word=“john” word_type=“noun” position=“1”
surfaceform=“\hat{ } john” />
  </semword>
```

Each of the expansions of the other semwords would be similarly represented, including appropriate synonyms and hypernym associated with the assigned roles. However, the relevant cross-products of the triples associated with this example would include the discrete set of triples:

john: eat: apple

john: eat: orange

mary: eat: apple

mary: eat: orange

The above triples represent simple, atomic, representations of the subject matter of the sentence. Additional facts can be added to any of the triples to create more complex tuples that can be used to produce visualizations that provide more detailed or focused information in response to a query. Thus, for example, the exemplary triples listed above could be enhanced to include information about when the events described (i.e., John and Mary eating an apple and an orange) took place, as follows:

John (subject), ate (relation), apple (object), April 3rd (date)

Mary (subject), ate (relation), apple (object), April 3rd (date)

Or

John (subject), ate (relation), orange (object), April 3rd (date), 9:15 a.m. (time)

Mary (subject), ate (relation), orange (object), April 3rd (date), 9:15 a.m. (time)

Accordingly, simple representations of the facts can be returned to a user in response to a query. The visualizations produced by tuples can include only the elements of the tuple or can include additional words such as indefinite articles that make the tuple easier to read. Thus, for example, visualizations corresponding to the above exemplary triples and tuples could include short phrases or sentences like the following:

John ate apple

John ate an apple

Mary ate apple April 3rd

Mary ate an apple at 9:15 a.m. on April 3^{rd}

Referring again to FIG. 7, at step 740, interest rules are applied to the resulting relevant tuples to filter out unnecessary or undesired tuples. Interest rules can include any number of various types of rules and/or heuristics. In an embodiment, tuples including pronouns are removed from the resulting set of cross-products. In another embodiment, tuples that include ambiguous words such as when, where, what, why, which, however, and the like are removed from the set of cross-products. In other embodiments, tuples that include mathematical symbols or formulae are removed. In embodiments, tuples can be filtered according to learned user preferences, characteristics of a particular search query, characteristics of the originating sentence, or any other consideration that may be useful in generating a beneficial user experience. Once filtered, a set of filtered tuples remains.

This set of filtered tuples includes tuples that will be relevant to a search that, for example, should return the document from which the originating sentence was extracted. To facilitate a more beneficial user experience, as explained above with respect to FIG. 2, the resulting tuples and/or the documents referenced by the tuples can be sorted, ranked, filtered, emphasized, and the like. In one embodiment, display options such as these can be selected, at least in part, according to annotations accompanying one or more of the set of resultant tuples. Accordingly, at step 750 in FIG. 7, the filtered tuples are annotated. In some embodiments, no annotations are made to the filtered tuples. In other embodiments, every filtered tuple is annotated and in further embodiments, only some of the filtered tuples are annotated.

Annotating tuples includes associating information with the tuple such as by appending, embedding, referencing or otherwise associating information with the tuple. Annotation data can include any type of data desired, and in one embodiment includes indicators of whether a relation is positive or negative. In this way, if the fact derived from the originating sentence was “people don't love dogs,” the same set of tuples could be used to represent this fact, and each of the expanded words associated with the semantic word representing love could be annotated with an indication that the relation is a negative one (i.e., don't love rather than do love). In the case of the example fact discussed above, the relation is positive, and thus, each expansion of the semantic word love can be annotated with an indication that the relation is positive. Additionally, annotations can reflect other aspects such as proper nouns, additional meanings, and the like. In one embodiment, as shown in the list of annotated resultant tuples below, each resultant tuple may be annotated with information indicating a ranking scheme associated therewith. Tuples also can be annotated with surface forms and meta information such as, for example, metadata that identifies the types of the elements within the tuple. The annotated resultant tuples of the above example fact might include the following:

people,love,dog [Rank=2; rel=positive]

people,love,dogs [Rank=1; rel=positive]

people,love,entity [Rank=3; rel=positive]

entity,love,dog [Rank=2; rel=positive]

entity,love,dogs [Rank=1; rel=positive]

Returning now to FIG. 6, in an embodiment, the output of tuple extraction and annotation 612 can include an indexing document 636 and an opaque data document 638. The indexing document 636 includes filtered tuples that are ready for indexing 614 in the tuple index 262. The opaque data document 638 includes data that is opaque to the tuple index 262, but that corresponds to filtered tuples in the indexing document 636. For example, the opaque data document 638 can include data that facilitates generation of visual representations of the filtered tuples in the indexing document 636. The opaque data document 638 is stored in the opaque storage 615 and is referenced, e.g., by pointers, by indexed tuples stored in the tuple index 262.

As an example, in an embodiment, the tuple extraction and annotation 612 process receives an XML document containing a large number of facts and relations, each of which further includes a large number of other facts and aspects. This document is stripped down so that it only contains tuples (and possibly corresponding annotations). The resulting XML document is sent to an indexing component for indexing 614 within the tuple index 262. Thus, for the example discussed above that included the fact “people love dogs,” input content semantics 610 corresponding thereto could be rendered as a lengthy XML file:

```
<?xml version=“1.0”?>
<sentence text=“&lt;X_namePerson_ID1&gt;
Jennifer&lt/X_namePerson_ID1&gt; also had
noticed how people in the &lt;X_nameLocation_ID2&gt;
Chelsea&lt/X_nameLocation_ID2&gt;
district all have dogs and LOVE their dogs so
she subverted &quot;lost dog&quot; posters.”
root=“ROOT” index-id=“37”>
<fact>
  <semword role=“so” rolehier=“so/evgrel/vgrel/root” sp_cmt=“a”
skolem=“40018”>
  <semcode syn=“overthrow#v#1” weight=“12” />
  <semcode hyp=“depose#v#1” weight=“12” />
  <semcode hyp=“oust#v#1” weight=“12” />
  <semcode hyp=“remove#v#2” weight=“12” />
  <semcode hyp=“entity#n#1” weight=“15” />
  <semcode syn=“sabotage#v#1” weight=“10” />
  <semcode hyp=“disobey#v#1” weight=“10” />
  <semcode hyp=“refuse#v#1” weight=“10” />
  <semcode hyp=“react#v#1” weight=“10” />
  <semcode hyp=“act#v#1” weight=“10” />
  <semcode syn=“subvert#v#4” weight=“10” />
  <semcode hyp=“destroy#v#2” weight=“10” />
  <semcode syn=“corrupt#v#1” weight=“10” />
  <semcode hyp=“change#v#2” weight=“10” />
  <original word=“subvert” word_type=“verb” position=“181”
surfaceform=“subverted” />
  </semword>
  <semword role=“sb” rolehier=“sb/root//RCP/whr/vgrel/root”
sp_cmt=“a” skolem=“10754”>
  <semcode syn=“person#n#1” weight=“14” />
  <semcode hyp=“organism#n#1” weight=“14” />
  <semcode hyp=“causal_agent#n#1” weight=“14” />
  <semcode hyp=“living_thing#n#1” weight=“14” />
  <semcode hyp=“object#n#1” weight=“14” />
  <semcode hyp=“physical_entity#n#1” weight=“14” />
  <semcode hyp=“entity#n#1” weight=“15” />
  <semcode syn=“people#n#1” weight=“7” />
  <semcode hyp=“group#n#1” weight=“8” />
  <semcode hyp=“abstraction#n#6” weight=“8” />
  <semcode hyp=“abstract_entity#n#1” weight=“8” />
  <semcode syn=“citizenry#n#1” weight=“2” />
  <original word=“people” word_type=“noun” position=“68”
surfaceform=“people” />
  </semword>
  <semword role=“ob” rolehier=“ob/root//T/vgrel/root” sp_cmt=“a”
skolem=“37374”>
  <semcode syn=“canine#n#2” weight=“13” />
  <semcode hyp=“carnivore#n#1” weight=“13” />
  <semcode hyp=“placental#n#1” weight=“13” />
  <semcode hyp=“mammal#n#1” weight=“13” />
  <semcode hyp=“vertebrate#n#1” weight=“13” />
  <semcode hyp=“chordate#n#1” weight=“13” />
  <semcode hyp=“animal#n#1” weight=“13” />
  <semcode hyp=“organism#n#1” weight=“14” />
  <semcode hyp=“living_thing#n#1” weight=“14” />
  <semcode hyp=“object#n#1” weight=“14” />
  <semcode hyp=“physical_entity#n#1” weight=“14” />
  <semcode hyp=“entity#n#1” weight=“15” />
  <semcode syn=“dog#n#1” weight=“13” />
  <semcode hyp=“canine#n#2” weight=“13” />
  <semcode syn=“dog#n#8” weight=“5” />
  <semcode syn=“pawl#n#1” weight=“4” />
  <semcode hyp=“catch#n#6” weight=“4” />
  <semcode hyp=“restraint#n#6” weight=“4” />
  <semcode hyp=“device#n#1” weight=“5” />
  <semcode hyp=“instrumentality#n#3” weight=“5” />
  <semcode hyp=“artifact#n#1” weight=“5” />
  <semcode hyp=“whole#n#2” weight=“5” />
  <semcode syn=“frank#n#2” weight=“4” />
  <semcode hyp=“sausage#n#1” weight=“4” />
  <semcode hyp=“meat#n#1” weight=“4” />
  <semcode hyp=“food#n#2” weight=“4” />
  <semcode hyp=“solid#n#1” weight=“4” />
  <semcode hyp=“substance#n#1” weight=“4” />
  <semcode syn=“andiron#n#1” weight=“4” />
  <semcode hyp=“support#n#10” weight=“4” />
  <semcode syn=“dog#n#3” weight=“4” />
  <semcode hyp=“chap#n#1” weight=“4” />
  <semcode hyp=“male#n#2” weight=“4” />
  <semcode hyp=“person#n#1” weight=“7” />
  <semcode hyp=“causal_agent#n#1” weight=“7” />
  <semcode syn=“frump#n#1” weight=“4” />
  <semcode hyp=“unpleasant_woman#n#1” weight=“4” />
  <semcode hyp=“unpleasant_person#n#1” weight=“4” />
  <semcode hyp=“unwelcome_person#n#1” weight=“5” />
  <semcode syn=“cad#n#1” weight=“4” />
  <semcode hyp=“villain#n#1” weight=“4” />
  <original word=“dog” word_type=“noun” position=“169”
surfaceform=“dogs” />
  </semword>
  <semword role=“how” rolehier=“how/how/root”
  sp_cmt=“a” skolem=“9834”>
  <semcode syn=“entity#n#1” weight=“15” />
  <original word=“what” word_type=“noun”
  position=“64” surfaceform=“how” />
  </semword>
  <semword rolehier=“relation/root” sp_cmt=“a” role=“relation”
skolem=“33650”>
  <semcode syn=“love#v#1” weight=“13” />
  <semcode hyp=“entity#n#1” weight=“15” />
  <semcode syn=“love#v#2” weight=“11” />
  <semcode hyp=“like#v#2” weight=“11” />
  <semcode syn=“love#v#3” weight=“9” />
  <semcode hyp=“love#v#1” weight=“13” />
  <original word=“love” word_type=“verb”
position=“158” surfaceform=“\hat{ }\hat{ } love” />
  </semword>
</fact>
</sentence>
```

However, after tuple extraction and annotation 612, an example of an indexing document 640 that corresponds to the above content semantics 610 could look like the following:

```
<?xml version=“1.0”?>
<sentence text=“&ltX_namePerson_ID1&gt;
Jennifer&lt/X_namePerson_ID1&gt; also
had noticed how people in the
&lt;X_nameLocation_ID2&gt;Chelsea&lt;
/X_nameLocation_ID2&gt; district all have
dogs and LOVE their dogs so she subverted
&quot;lost dog&quot; posters.”
root=“ROOT” index-id=“37”>
  <fact index-id=“262”>
  <semword role=“sb” sp_cmt=“a”>
    <semcode hyp=“entity#n#1”/>
    <original word=“people” word_type=“noun”
    position=“68” surfaceform=“people”/>
  </semword>
  <semword role=“ob” sp_cmt=“a”>
    <semcode hyp=“entity#n#1”/>
    <original word=“dog” word_type=“noun”
    position=“169” surfaceform=“dogs”/>
  </semword>
  <semword sp_cmt=“a” role=“relation”>
    <semcode hyp=“entity#n#1”/>
    <original word=“love” word_type=“verb” position=“158”
    surfaceform=“\hat{ }\hat{ } love”/>
  </semword>
  </fact>
</sentence>
```

Furthermore, the opaque data document 638 corresponding to this example might appear as follows:

<?xml version=“1.0”?>
<sentence index-id=“37” type=“PM”
text=“&lt;X_namePerson_ID1&gt;
Jennifer&lt/X_namePerson_ID1&gt; also had noticed how
people in the &lt;X_nameLocation_ID2&gt;
Chelsea&lt;/X_nameLocation_ID2&gt; district all
have dogs and LOVE their dogs so she
subverted &quot;lost dog&quot; posters.”>
<fact index-id=“262”><![CDATA[{triples,}
{people,people,common,68,,,}{love,\hat{ }\hat{ }
love,,158,,,}{dog,dogs,common,169,,,}]]></fact>
</sentence>

With continuing reference to FIG. 6, the tuple index 262 can be queried by users to return indexed tuples that are presented as a result of generating visualizations derived from opaque data 642 from the opaque storage 615. A query 225 can be processed, as in the embodiment of FIG. 6, in the query conditioning pipeline 205. As illustrated, the query 225 is first conditioned through a query parsing 620 process. In an embodiment, query parsing 620 includes translating the query 225 into a query language that can be used to query the tuple index 262. In one embodiment, query parsing 620 includes semantic interpretation such as that described with reference to the semantic interpretation component 245 illustrated in FIG. 2. In other embodiments, query parsing 620 may include identifying words and corresponding roles from the query language. The query 225 can be a structured query or a natural language query.

The parsed query 646 is then conditioned through the tuple query generation 622 process. In an embodiment, tuple query generation 622 includes deriving a search tuple that can be compared against the indexed tuples stored in the tuple index 262. In an embodiment, the query 225 can be a structured query that is in the form of, for example, an incomplete tuple, in which case the query 225 is only translated into an appropriate query language in the query conditioning pipeline 205. In still a further embodiment, the query 225 includes a complete tuple that can be compared against the tuples stored in the tuple index 262.

The resulting tuple query 648 includes a search tuple that can include one or more tuple elements such as, for example, a first word and a first role corresponding to the first word, possibly a second word and a second role corresponding to the second word, and possibly a third word and a third role corresponding to the third word. In embodiments, the tuple query 648 can include any number of tuple elements, regardless of the number of elements associated with any of the indexed tuples stored in the tuple index 262. If the tuple query 648 includes an incomplete tuple, the incomplete tuple consists of one or more words and corresponding roles and one or more missing elements.

Missing, or unassigned, elements (that is, elements that are not assigned a word and/or corresponding role) can be assigned a wildcard word and/or role. For example, a tuple query 648 might include a first word and a corresponding first role, a second word and a corresponding second role, but no third word or corresponding third role. Such a tuple query might include, for example: people.sb; love.rel.; and wildcard.wildcard. As another example, a tuple query 648 might include a word without a corresponding role such as: people.wildcard; love.rel.; dogs.ob or people.wildcard; love.rel; wildcard.ob. Any other combinations of the above can also be possible, including for example, a query that includes only a first word with no corresponding roles: love.wildcard; wildcard;wildcard; wildcard;wildcard. A final example of a query might include a first word and a corresponding first role and a second and third word, neither of which have a corresponding role: love.rel; people.wildcard; dogs;wildcard. It should be understood that this last example may return tuples that include such facts as, for example, people love dogs and dogs love people.

As further illustrated in FIG. 6, the tuple query 648 is sent to the retrieval 624 process where it is compared against the indexed tuples stored in the tuple index 262 to identify relevant matches. Upon identifying one or more relevant matches, the corresponding opaque data 643 is returned and the documents and/or tuples included therein can be ranked, filtered, emphasized, inflected and the like at 626. The results are aggregated to create a search result set 286 which can be rendered to a user as an aggregate tuple display 628. In embodiments, tuples are displayed along with document snippets or other content. In other embodiments, only the aggregate tuples are displayed.

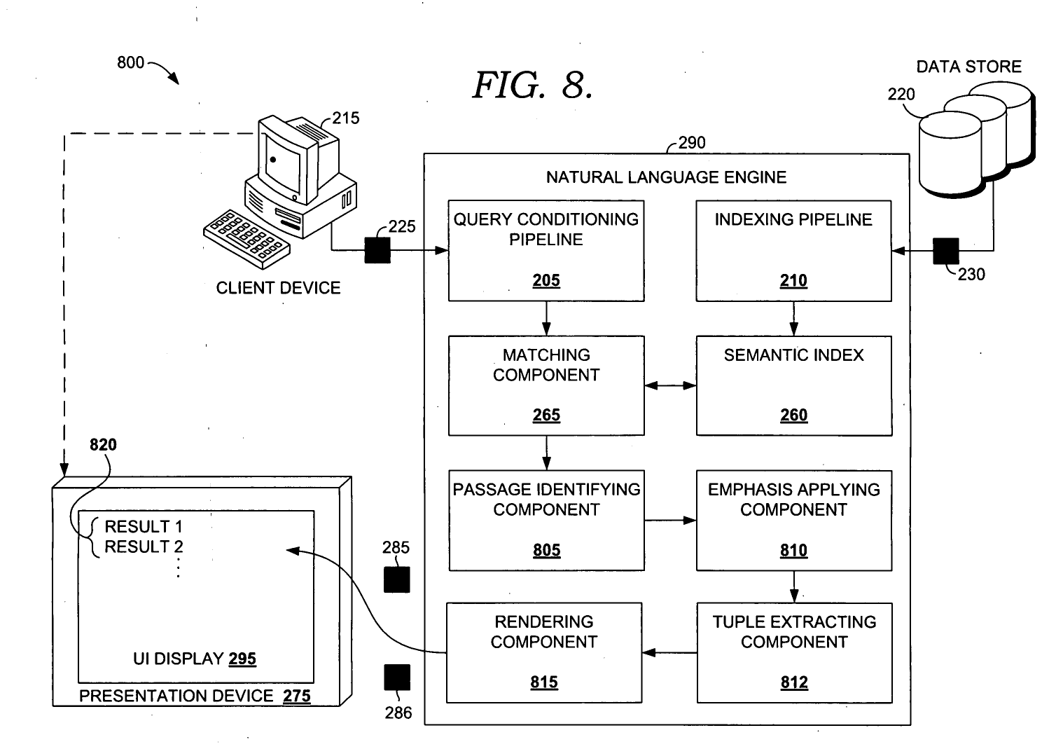

Although the invention has so far been described according to embodiments as illustrated in FIGS. 2, 3, 4, 5, and 6, other embodiments of the present invention can be implemented and can include any number of features similar to those previously described. In one embodiment, as illustrated in FIG. 8, the tuple extraction process can be implemented independent of the indexing pipeline 210. That is, the system can be configured to index content according to any number of various methods such as, for example, those described herein with reference to parsing and semantic interpretation. A query can be applied, whether it is conditioned or not, to the resulting semantic index, and tuples can subsequently be extracted from the search results. It should be understood that such an embodiment can entail increased processing burdens and decreased throughput. However, embodiments such as the exemplary implementation illustrated in FIG. 8 can be adapted for use with other types of search engines, whether they are semantic search engines or not. In this way, the tuple extraction and annotation process described herein can be versatile and may be appended to any number of different types of searching systems.

Turning specifically to FIG. 8, the natural language engine 290 may take the form of various types of computing devices that are capable of emphasizing a region within a search result that is selected upon matching the proposition derived from the query to the semantic structures derived from content within the documents 230 housed at the data store 220 or elsewhere (e.g., a storage location within the search scope of, and accessible to, the natural language engine 290). Initially, these computer software components include the query conditioning pipeline 205, the indexing pipeline 210, the matching component 265, the semantic index 260, a passage identifying component 805, an emphasis applying component 810, a tuple extracting component 812, and a rendering component 815. It should be noted that the natural language engine 290 of the exemplary system architecture 200 depicted in FIG. 2 is but one example of a suitable environment that may be implemented to carry out aspects of the present invention and is not intended to suggest any limitation as to the scope of use or functionality of the invention. Neither should the illustrated natural language engine 290, of the system 200, be interpreted as having any dependency or requirement relating to any one or combination of the components 205, 210, 260, 265, 805, 810, 812, and 815 as illustrated in FIG. 8. Accordingly, similar to the system architecture 200 of FIG. 2, any number of components may be employed to achieve the desired functionality within the scope of embodiments of the present invention.

In general, the query conditioning pipeline 205 is employed to derive a proposition from the query 225. In one instance, deriving the proposition includes receiving the query 225 that is comprised of search terms, and distilling the proposition from the search terms. Typically, as used herein, the term “proposition” refers to a logical representation of the conceptual meaning of the query 225. In instances, the proposition includes one or more logical elements that each represent a portion of the conceptual meaning of the query 225. Accordingly, the regions of content that are targeted and emphasized upon determining a match include words that correspond with one or more of the logical elements. As discussed above, with reference to FIG. 2, the query conditioning pipeline 205 encompasses the query parsing component 235, which receives the query 225 from a client device, and the first semantic interpretation component 245, which derives the proposition from the query 225 based, in part, on a semantic relationship of the search terms.

In embodiments, the indexing pipeline 220 is employed to derive semantic structures from at least one document 230 that resides at one or more local and/or remote locations (e.g., the data store 220). In one instance, deriving the semantic structures includes accessing the document 230 via a network, distilling linguistic representations from content of document, and storing the linguistic representations within a semantic index as the semantic structures. As discussed above, the document 230 may comprise any assortment of information, and may include various types of content, such as passages of text or character strings. Typically, as used herein, the phrase “semantic structure” refers to a linguistic representation of content, thereby capturing the conceptual meaning of a portion, or preposition, within the passage. In instances, the semantic structure includes one or more linguistic items that each perform a grammatical function. Each of these linguistic items are derived from, and are mapped to, one or more words within the content of a particular document. Accordingly, mapping the semantic structure to words within the content allows for targeting these words, or “region,” of the content upon ascertaining that the semantic structure matches the proposition.

As discussed above, with reference to FIG. 2, the indexing pipeline 220 encompasses the document parsing component 240, which inspects the data store 220 to access at least one document 230 and the content therein, and the semantic interpretation component 250 that utilizes lexical functional grammar (LFG) rules to derive the semantic structures from the content. Although one implementation/algorithm for deriving semantic structures has been described, it should be understood and appreciated by those of ordinary skill in the art that other types of suitable heuristics that distill a semantic structure from content may be used, and that embodiments of the present invention are not limited to tools for extracting semantic relationships between words, as described herein.

As discussed above, the matching component 265 is generally configured for comparing the proposition against the semantic structures held in the semantic index 260 to determine a matching set. In a particular instance, comparing the proposition and the semantic structure includes attempting to align the logical elements of the proposition with the linguistic items of the semantic structure to ascertain which semantic structures best correspond with the proposition. As such, there may exist differing levels of correspondence between semantic structures that are deemed to match the proposition.

According to embodiments, the function of the semantic index 260 (i.e., store the semantic structures in an organized and searchable fashion), can remain substantially similar between embodiments of the natural language engine 290 as illustrated in FIG. 2 and FIG. 8, and will not be further discussed.

The passage identifying component 805, is generally adapted to identify the passages that are mapped to the matching set of semantic structures. In addition, the passage identifying component 805 facilitates identifying a region of content within the document 230 that is mapped to the matching set of semantic structures. In embodiments, the matching set of semantic structures is derived from a mapped region of content. Consequently, the region of content may be emphasized (e.g., utilizing the emphasis applying component 810), with respect to other content of the search results 285, when presented to a user (e.g., utilizing the presentation device 275).

It should be understood and appreciated that the designation of “region” of content, as used herein, is not meant to be limiting, and should be interpreted broadly to include, but is not limited to, at least, one of the following grammatical elements: a contiguous sequence of words, a disconnected aggregation of words and/or characters residing in the identified passages, a proposition, a sentence, a single word, or a single alphanumeric character or symbol. In another example, the “passages” of the content, at which the regions are targeted, may comprise one or more sentences. And, the regions may comprise a sequence of words that is detected by way of mapping content to a matching semantic representation.

As such, a procedure for detecting the region within the identified passage may include the steps of detecting a sequence of words within the identified passages that are associated with the matching set of semantic representations, and, at least temporarily, storing the detected sequence of words as the region. Further, in embodiments, the words in the content of the document 230 that are adjacent to the region may make up the balance of a body of the search result 285. Accordingly, the words adjacent to the region may comprise at least one of a sentence, a phrase, a paragraph, a snippet of the document 230, or one or more of the identified passages.

In one embodiment, the passage identifying component 805 employs a process to identify passages that are mapped to the matching set of semantic representations. Initially, the process includes ascertaining a location of the content from which the semantic representations are derived within the passages of the document 230. The location within the passages from which the semantic representations are derived may be expressed as character positions within the passages, byte positions within the passages, Cartesianal coordinates of the document 230, character string measurements, or any other means for locating characters/words/phrases within a 2-dimensional space. In one embodiment, the step of identifying passages that are mapped to the matching set of semantic representations includes ascertaining a location within the passages from which the semantic representations are derived, and appending a pointer to the semantic representations that indicates the locations within the passages. As such, the pointer, when recognized, facilitates navigation to an appropriate character string of the content for inclusion into an emphasized region of the search result(s) 285.

Next, the process may include writing the location of the content, and perhaps the semantic representations derived therefrom, to the semantic index 260. Then, upon comparing the proposition against function structures retained in the semantic index 260 (utilizing the matching component 265), the semantic index 260 may be inspected to determine the location of the content associated with the matching set of semantic representations. Further, in embodiments, the passages within the content of document may be navigated to discover the targeted location, or region, of the content. This targeted location is identified as the relevant portion of the content that is responsive to the query 225.

The emphasis applying component 810 is generally configured for using various techniques to emphasize particular sequences of words encompassed by the regions. Examples of such techniques can include highlighting, bolding, underlining, isolating, and the like.

The document snippets and/or documents 230 outputted from the emphasis applying component 810 can be processed by the tuple extraction component 812 before being rendered for display by the rendering component 815. The function of the tuple extraction component 812 (i.e., extracting and annotating tuples), remains substantially similar between the various embodiments of the present invention, for example, as illustrated in FIG. 2 and FIG. 6, and will not be further discussed except to emphasize that the input taken by the tuple extraction component 812 need not include content semantics or parsed content, but can include content itself such as, for example, semantic structures, documents, regions of documents, document snippets, and the like. As a result, resultant tuples 286 can be rendered in addition to search results 285 and can be similarly ranked.

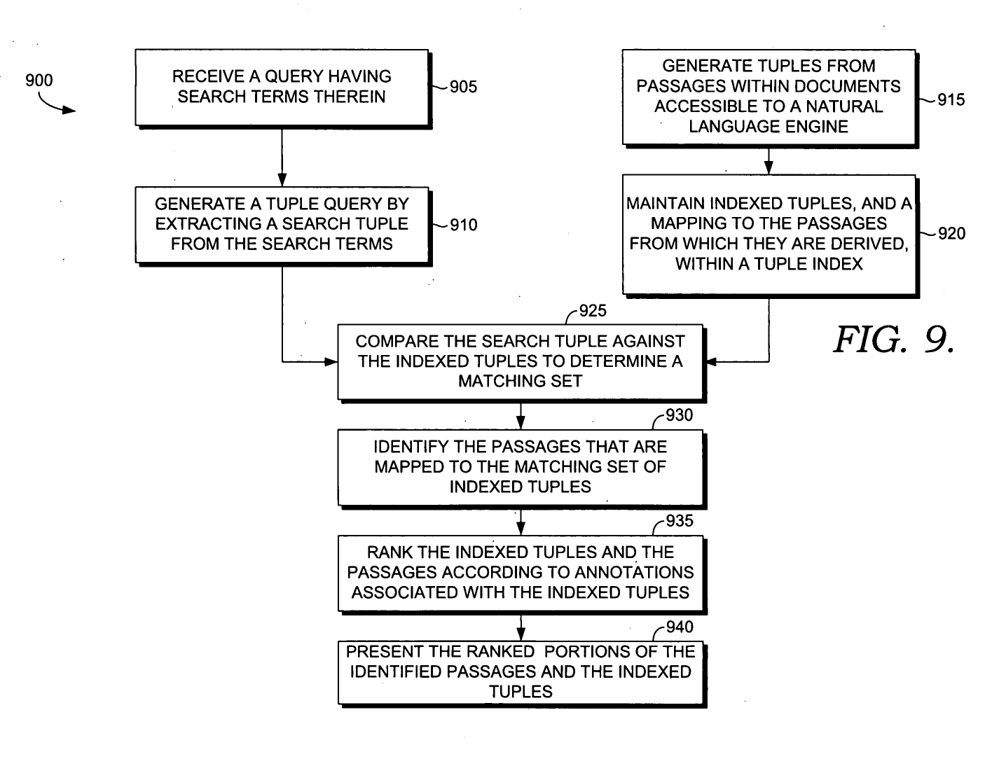

Turning now to FIG. 9, a flow diagram is illustrated that shows an exemplary method for facilitating user navigation of search results by presenting relational tuples that summarize facts associated with the search results, in accordance with an embodiment of the present invention. Initially, a query that includes one or more search terms therein is received from a client device at a natural language engine, as depicted at block 905. As depicted at block 910, a tuple query may be generated by extracting a search tuple from the search terms. In an embodiment, the search tuple can be an incomplete tuple, whereas in other embodiments, a complete tuple can be extracted. As depicted at block 915, tuples are generated from passages/content within documents accessible to the natural language engine. As discussed above, the tuples are generally simple linguistic representations derived from content of passages within one or more documents and include at least two elements. As depicted at block 920, the indexed tuples, and a mapping to the passages from which they are derived, are maintained within a tuple index.

As depicted at block 925, the search tuple is compared against the indexed tuples retained in the tuple index to determine a matching set. The passages that are mapped to the matching set of indexed tuples are identified, as depicted at block 930. Rankings may be applied to the indexed tuples and passages according to annotations associated with the indexed tuples, as shown at block 935. The ranked portions of the identified passages and indexed tuples may be presented to the user as the search results relevant to the query, as shown at block 940. Accordingly, the present invention offers relevant search results that include easily navigable tuples that correspond with the true objective of the query and allow for convenient browsing of content. In an embodiment, a set of matching tuples and the passages that are mapped thereto can be presented. In another embodiment, a subset of the matching tuples and/or passages can be presented. It should be understood that a subset of a set, as used herein, can include the entire set itself.

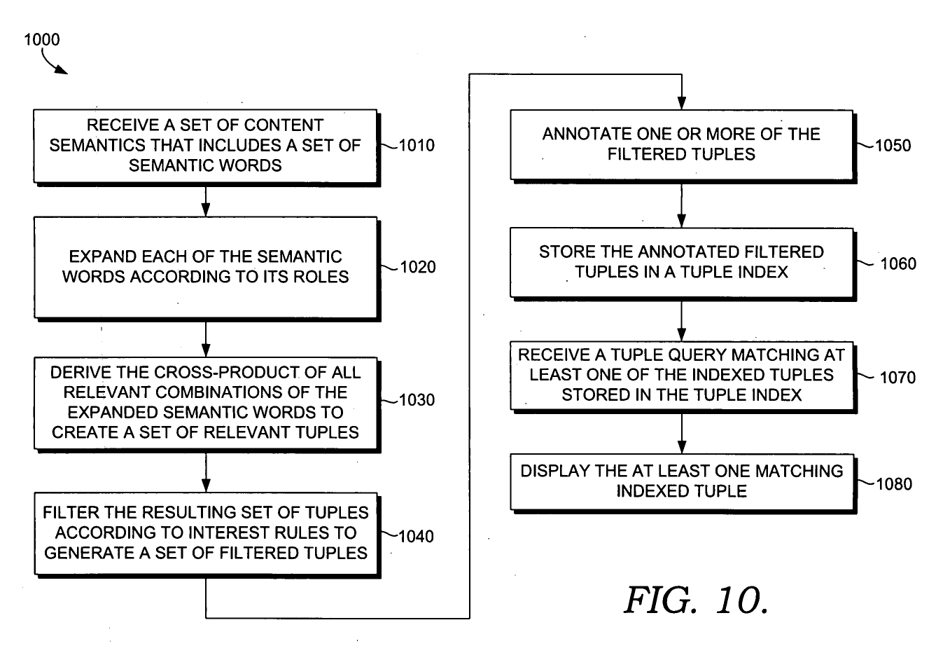

Turning to FIG. 10, another method of facilitating user navigation of search results by presenting relational tuples that summarize facts associated with the search results, in accordance with embodiments of the present invention is shown. At a step 1010, a set of content semantics that includes a set of semantic words is received. Each of the semantic words is expanded according to its roles, as shown at step 1020. At step 1030, all of the relevant cross-products of the expanded semantic words are derived to create a set of relevant tuples.

At step 1040, the resulting set of tuples is filtered according to interest rules to generate a set of filtered tuples. At 1050 one or more of the filtered tuples is annotated and at step 1060, the filtered tuples are stored in a tuple index. As further shown at step 1070, a tuple query is received that matches at least one of the indexed tuples stored in the index and, as shown at step 1080, the at least one matching indexed tuple is displayed.

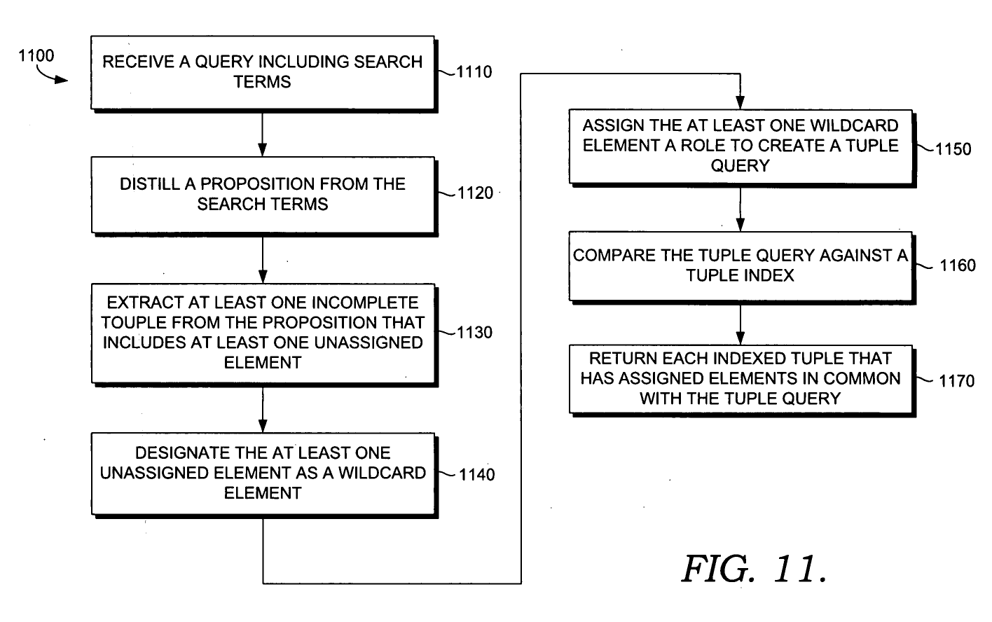

Turning to FIG. 11, another illustrative method of facilitating user navigation of search results by presenting relational tuples that summarize facts associated with the search results, according to embodiments of the present invention is shown. At step 1110, a query is received that includes search terms. As shown at step 1120, a proposition is distilled from the search terms. At step 1130, at least one incomplete tuple is extracted from the proposition. In an embodiment, the at least one extracted element includes one or more unassigned elements. The one or more unassigned elements are designated, as shown at step 1140, as wildcard elements and at least one wildcard element is assigned a role at step 1150 to create a tuple query consisting of a search tuple. The tuple query is compared against indexed tuples stored in a tuple index, as shown at step 1160, and each indexed tuple that has assigned elements in common with the tuple query is returned at step 1170.

The present invention has been described in relation to particular embodiments, which are intended in all respects to be illustrative rather than restrictive. Alternative embodiments will become apparent to those of ordinary skill-in-the-art to which the present invention pertains without departing from its scope. For example, in an embodiment, the systems and methods described herein can support access by devices via application programming interfaces (APIs). In such an embodiment, the API exposes the primitive operations that are also used to enable graphical interaction by users. An example of such a primitive operation includes a function call that, given a semantic query, returns clustered results in a structured form. In other embodiments, the system and methods can support customization such as user-contributed ontologies and customized ranking and clustering rules, enabling third parties to build new applications and services on top of the core capabilities of the present invention.

In further embodiments, the system and methods described herein can support user feedback. In one embodiment, users can select a presented cluster, relation, or snippet of a document, and give a positive or negative vote or similar response such as comments, questions, recommendations, and the like. User feedback can be stored in a database and used automatically or semi-automatically to modify underlying knowledge and capabilities associated with embodiments of the semantic indexing systems, ranking systems, or presentation systems described herein.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

The invention claimed is:

1. One or more computer-readable media having computer-executable instructions embodied thereon for performing a method of facilitating user navigation of search results by presenting relational tuples that summarize facts associated with the search results, the method comprising:
receiving a query comprising one or more search terms selected by a user;
identifying a relevant passage in a document, wherein the relevant passage satisfies the query;
extracting a relevant tuple from the relevant passage, the relevant tuple representing a fact expressed within the relevant passage, wherein the fact satisfies the query; and
presenting to the user at least one of the relevant passage and a representation of the relevant tuple.

2. The one or more computer-readable media of claim 1, further comprising:
generating a tuple query comprising a search tuple extracted from the one or more search terms; and
comparing the search tuple against a plurality of indexed tuples stored in a tuple index to identify the relevant tuple, wherein the relevant tuple has been extracted from, and is mapped to, the relevant passage.

3. The one or more computer-readable media of claim 2, wherein the search tuple comprises at least one role element having a wildcard word assigned thereto.

4. The one or more computer-readable media of claim 2, wherein each of the plurality of indexed tuples includes at least a subject or object role and a relation.

5. The one or more computer-readable media of claim 4, wherein each of the subject or object role and the relation has a corresponding word assigned thereto.

6. The one or more computer-readable media of claim 2, further comprising:
identifying a plurality of additional relevant tuples from the tuple index, wherein at least one of the plurality of additional relevant tuples represents a fact expressed within at least one additional relevant passage;
ranking the relevant passage and the at least one additional relevant passage according to an annotation associated with at least one of the relevant tuples; and
presenting the at least one additional relevant passage and a representation of each of a subset of the plurality of additional relevant tuples.

7. The one or more computer-readable media of claim 6, wherein the at least one annotation comprises information derived from user feedback.

8. The one or more computer-readable media of claim 7, wherein the representation of each of the subset is generated using data that is opaque to the tuple index.

9. The one or more computer-readable media of claim 8, wherein at least one representation comprises a hyperlink to a corresponding relevant passage.

10. One or more computer-readable media having computer-executable instructions embodied thereon for performing a method of facilitating user navigation of search results by presenting relational tuples that summarize facts associated with the search results, the method comprising:
receiving a set of content semantics comprising a set of semantic words, wherein each of the set of semantic words comprises a word and a corresponding role;
expanding each of the semantic words according to its corresponding role to generate a plurality of tuple elements, wherein expanding each of the at semantic words comprises identifying a hypernym associated with each of the semantic words;
deriving a cross-product of tuple elements from the plurality of tuple elements to generate a plurality of relevant tuples, wherein each of the plurality of relevant tuples comprises a fact associated with the set of content semantics;
creating a set of filtered tuples by applying at least one interest rule to filter the plurality of relevant tuples and indexing the filtered tuples in a tuple index to create indexed tuples;
receiving a tuple query that comprises a search tuple; and
presenting a set of matching indexed tuples in response to the tuple query, wherein the set of matching indexed tuples comprises indexed tuples having one or more elements in common with the search tuple.

11. The one or more computer-readable media of claim 10, wherein the search tuple comprises an incomplete tuple that includes at least one tuple element having an unassigned role.

12. The one or more computer-readable media of claim 10, wherein the search tuple comprises an incomplete tuple that includes at least one tuple element having an unassigned word with a corresponding assigned role.

13. The one or more computer-readable media of claim 10, wherein each of the indexed tuples comprises:
a first word corresponding to a subject role;
a second word corresponding to an object role; and
a third word corresponding to a relation role.

14. The one or more computer-readable media of claim 13, wherein each of the indexed tuples further comprises a fourth word corresponding to a time role.

15. The one or more computer-readable media of claim 10, wherein the at least one interest rule comprises a filter that eliminates tuples containing pronouns.

16. The one or more computer-readable media of claim 10, wherein the at least one interest rule filters the relevant tuples on the basis of learned user preferences.

17. The one or more computer-readable media of claim 10, wherein presenting the set of matching indexed tuples comprises generating a representation of the set of matching indexed tuples using data that is opaque to the tuple index.

18. A computer system capable of presenting at least one relational tuple as part of a search result that presents at least one document in response to a query, the computer system comprising a computer storage medium having a plurality of computer software components embodied thereon, the computer software components comprising:
a query parsing component that receives the search terms from a client device;
a document parsing component that inspects a data store, over a network, to access the at least one document and the content therein;
a tuple extraction component that extracts the at least one relational tuple from the at least one document; and
a rendering component that causes a passage from the at least one document and a representation of the at least one relational tuple to be displayed via the client device.

19. The system of claim 18, further comprising:
a semantic interpretation component that derives a proposition from the search terms based on a semantic relationship of the search terms, wherein the proposition is a logical representation of a conceptual meaning of the search terms;
a tuple query component that extracts a tuple query from the proposition, the tuple query comprises a search tuple representing a fact associated with the conceptual meaning of the search terms; and
a matching component that compares the search tuple against a plurality of indexed relational tuples stored in a tuple index to identify a matching indexed relational tuple, wherein the matching indexed relational tuple comprises a pointer to the at least one document.

20. The system of claim 19, further comprising an opaque storage component for storing opaque data that is used to generate a representation of the at least one relational tuple.
